(19) United States
(12) Patent Application Publication
(10) Pub. No.: US 2007/0061349 A1
(43) Pub. Date: Mar. 15, 2007

(54) Hierarchically describing shapes

(75) Inventors: Ashley L. Morgan, Santa Clara, CA (US); Barn-Wan Li, San Jose, CA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/228,616

(22) Filed: Sep. 15, 2005

(51) Int. Cl. G06F 7/00

(52) U.S. Cl. 707/101

(57) ABSTRACT

A hierarchical file format is provided for representing shapes associated with a graphical object. The file format is defined according to a schema. The hierarchical file format includes group properties that are applied to a group of shapes and shape properties that are applied to particular shapes. The hierarchical file format is arranged to provide legacy support for versioning of applications when the applications do not support other graphical object structures. The hierarchical file format may additionally be arranged to represent the shapes when the graphical object is transferred between documents. Also, the hierarchical file format may be arranged to provide representation of the shapes when the other structures for representing the shapes are not currently available.

### BACKGROUND

Markup Languages have attained wide popularity in recent years. One type of markup language, Extensible Markup Language (XML), is a universal language that provides a way to identify, exchange, and process various kinds of data. For example, XML is used to create data structures that can be utilized by a variety of application programs. Elements of an XML file have an associated namespace and schema.

In XML, a namespace is commonly used to uniquely identify each XML data structure. Each XML document can use a namespace to allow processes to easily identify the type of XML associated with the document. The unique namespaces may also assist to differentiate markup elements that come from different sources and happen to have the same name.

A namespace is also just one part of a unique identifier. XML data structures may also include ‘types’, ‘elements’, and ‘attributes’. Each of these may have a ‘name’ along with their namespace. It is the namespace together with the name that then uniquely identifies the type, element, or attribute.

An XML Schema provides a way to describe and validate data in an XML environment. A schema states what elements and attributes are used to describe content in an XML data structure, where each element is allowed, and which element can appear within other elements. The use of a schema ensures that the file is structured the same way. A schema may be created by a user and generally supported by an associated markup language, such as XML. By using an XML editor that supports schema, the user can manipulate the XML file and generate XML data structures that adhere to the schema the user has created. An XML document is often considered to be “valid” if it conforms/adheres to an XML schema. An XML document is said to be “well-formed” if it has matching open/close tags, no duplicate attribute values on a given element, and meets other requirements for well-formed code. Each XML schema is usually unique and requires significant individual development.

### SUMMARY

Aspects of the system and methods described herein are generally related to providing an XML file format that hierarchically describes shapes. This file format, referred to herein as GVML, corresponds to an XML schema that provides a language for describing a hierarchy of vector shapes. More generally, GVML provides a way of describing a hierarchical set of shapes and text. The hierarchy provided by GVML is organized into nodes and levels. Each node may have associated shape properties that describe how the shapes render. Additionally, each level may have its own set of properties that affect the rendering of a group of shapes. Additionally, the leaf nodes in the hierarchy (leaf nodes refer to the lowest nodes of the hierarchy) may have their own associated property storage structure that provides a list of properties to be applied to a particular shape or a particular block of text.

The GVML provides a description of shapes that may be used in the context of a system for embedded graphical objects. Newer novel systems are being implemented that allow graphical objects to be embedded in documents generated by other applications such that these objects interact as expected with the host application's functionality. The graphical objects may be edited within the host application according to the native functionality of the application in which it was created. For example, a copied organizational chart into a host application displays and functions equivalently to the chart as it appears in its native application which created it. These newly implemented systems take advantage of particular data structures, including a new hierarchical data structure for storing the properties associated with a particular shape. However, as these new embedding solutions are disseminated to the customers, a versioning support problem arises. GVML solves this problem by providing a legacy version of the graphical object generated according to the new system. When embedded graphical objects are included in a document that is generated according to the new system, a user of previous solutions is still able to view these embedded graphical objects.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device that may be used in one exemplary embodiment;

FIG. 2 shows a block diagram of an exemplary system for integrating a graphical object in a host application;

FIG. 3 illustrates a functional block diagram of an exemplary hierarchical shape property storage;

FIG. 4 illustrates a screenshot of an exemplary embedded graphical object that corresponds to an organizational chart;

FIG. 5 illustrates a functional block diagram of an example hierarchy for organizing the properties of the shapes; and

FIG. 6 shows a logical flow diagram of an exemplary process for rendering shapes according to a hierarchical file format, in accordance with one embodiment of the present invention.

### DETAILED DESCRIPTION

Embodiments of the present invention are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. Embodiments of the present invention may be practiced as methods, systems or devices. Accordingly, embodiments of the present invention may take the form of an entirely hardware implementation, an entirely software implementation or an implementation combining software and hardware aspects. The following detailed description is, therefore, not to be taken in a limiting sense.

The logical operations of the various embodiments of the present invention are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments of the present invention described herein are referred to alternatively as operations, steps or modules.

Illustrative Operating Environment

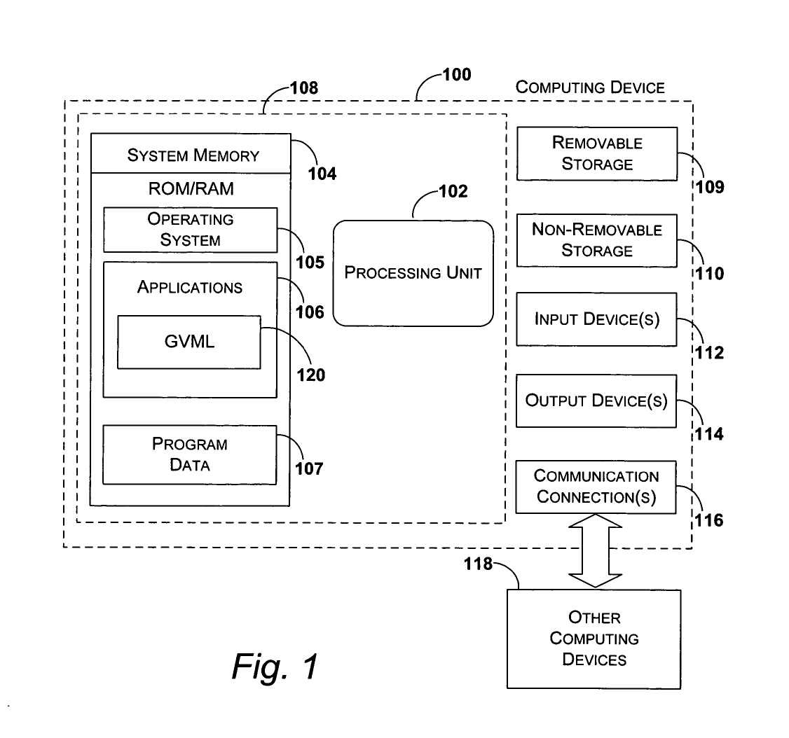

With reference to FIG. 1, one exemplary system for implementing the invention includes a computing device, such as computing device 100. Computing device 100 may be configured as a client, a server, mobile device, or any other computing device. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 includes a GVML application 120 for implementing the system of the present invention. This basic configuration is illustrated in FIG. 1 by those components within dashed line 108.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

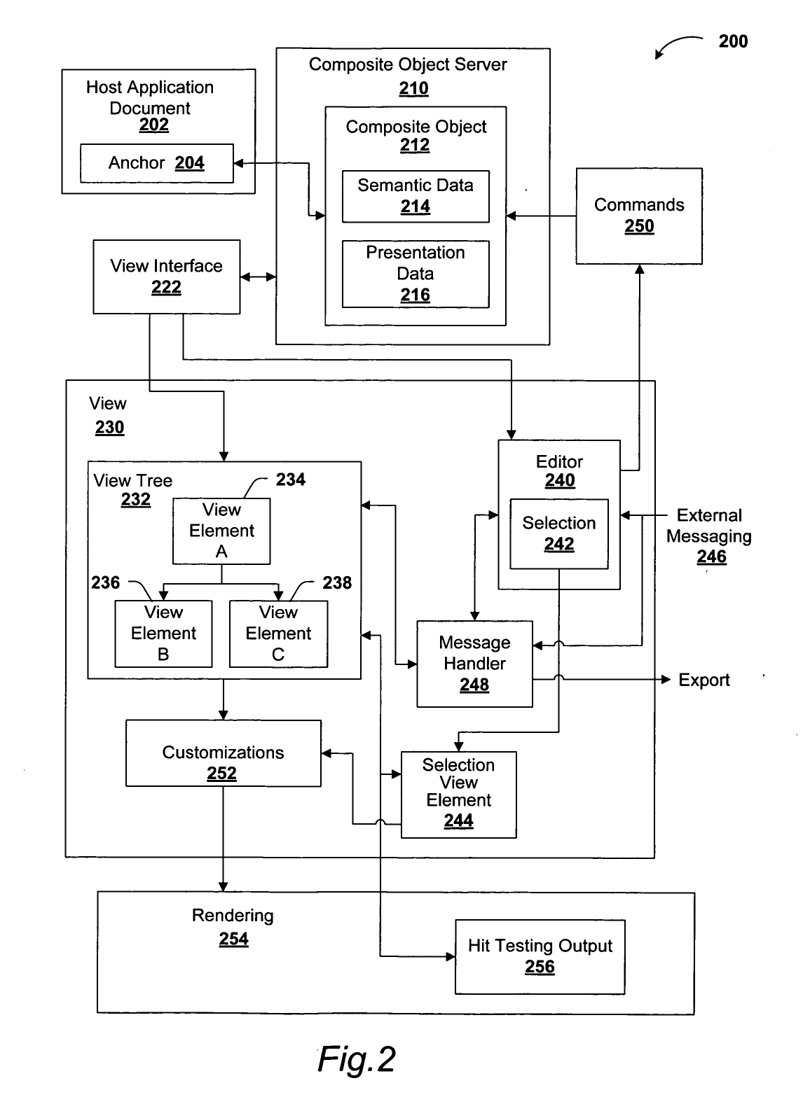

FIG. 2 shows a block diagram of an exemplary system for integrating a composite object in a host application in accordance with one embodiment of the present invention. System 200 for integrating an embedded graphical object into a document provides various improvements over other embedded object designs. However, system 200 may be unsupported fully by some applications. When an application receives a composite object as provided by system 200 and the application does not provide full support for the functionality associated with composite objects, the file format (i.e., GVML) of the present invention provides an alternate method for representing the shapes of the graphical object. When a user inserts GVML into that application (via copy/paste or drag/drop) the application reads/processes that GVML and converts it into a form that can be natively understood and rendered by the application. In this way, GVML is used as a common language across applications for transferring shape hierarchies from one application to another. The terms composite object and graphical object are used interchangeably herein to denote an object that includes shapes and may be represented according to shape properties and text. System 200 includes host application document 202, composite object server 210, view interface 222, view 230, commands module 250, rendering layer 254, and external messaging input 246.

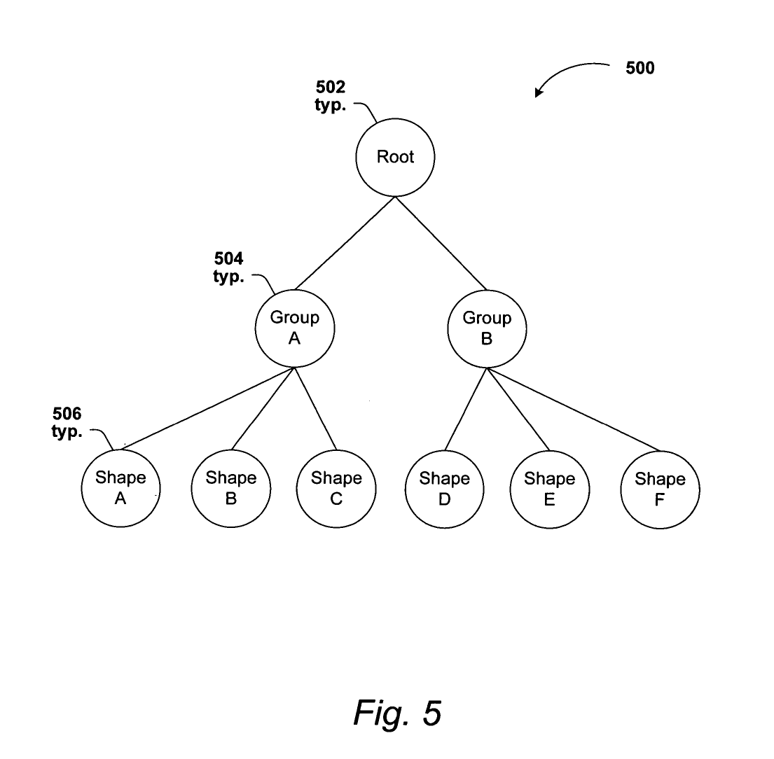

Host application document 202 includes anchor 204. Anchor 204 is a placeholder that designates the presence of a composite object (e.g., 212). In one embodiment, the application document is written in an extensible markup language (XML) and the anchor is a tag in the XML that references the composite object. Anchor 204 is defined in a format of the host application and is owned by host application document 202. Anchor 204 designates the placement and positioning of the composite object in host application document 204 when the host application document is rendered. Additional embodiments include additional anchors referenced in host application document 204, where additional composite object servers and additional composite objects may be associated with these anchors. Rendering of the composite objects included in a particular host application is discussed further below with reference to FIG. 5.

Composite object server 210 is a server that is called for loading a composite object shown as composite object 212. Composite object 212 further comprises semantic data 214 and presentation data 216. In one embodiment, semantic data 214 corresponds to the underlying data that provides the relationship between the shapes of composite object 212. For example, for a composite object that corresponds to an organizational chart, semantic data 214 corresponds to the hierarchy of positions within the organization. Generally, semantic data 214 includes the information that distinguishes one instance of a composite object from another instance of that same composite object. In contrast, presentation data 216 may be the same for different instances of the same composite object. Some examples of semantic includes a data series (i.e. rows and columns of data) for a chart composite object, a sequence or hierarchy of text (i.e. a multi-level outline) for a diagram composite object, a set of rows, columns, and text for a table composite object, and the like. Depending on the particular composite object, the logic that creates the hierarchy of shapes/group shapes from semantic data 214 may be wholly contained in the runtime code or it may read some parameters from the persisted data. System 200 therefore allows the composite objects to store data other than just that hierarchy of shapes or group shapes. In contrast to semantic data 214, presentation data 216 correspond to the layout data of the composite object.

Composite object server 210 implements view interface 222 in response to a query from view 230 when anchor 204 is discovered while creating view 230 for host application document 202. Once view interface 222 is created, it is then owned by view 230. View interface 222 creates the view elements (e.g., 234) and the editors (e.g., 240) associated with view 230 so that the view may be rendered and edited. In one embodiment, the view elements and editors are generated on an “on demand” basis. Generating the view elements and editors “on demand” refers to creating them when needed, and generally not significantly before they are needed.

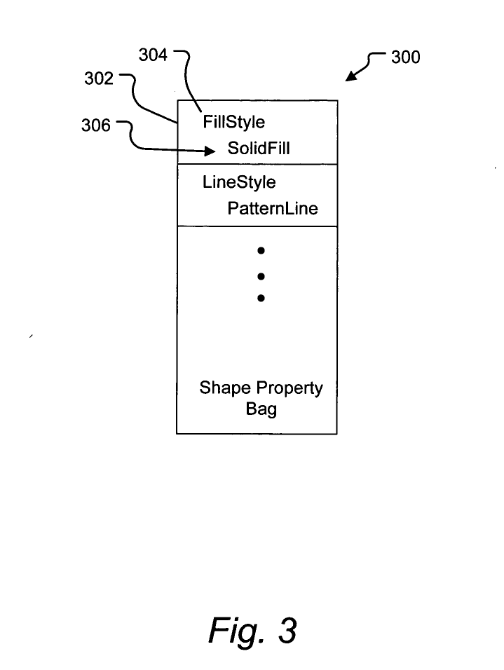

View 230, as shown, includes view tree 232, editor 240, selection view element 244, message handler 248, and customizations module 252. View tree 232 may include one or more view elements (e.g., 234, 236, 238) that are aggregated to form a renderable view of host application document 202. In one embodiment, each view element (e.g., 234, 236, 238) may include one or more shape property bags (SPBs) that describes the hierarchy of visual shapes included in view 230. An example structure for an SPB is discussed below with reference to FIG. 3. Each view element includes information about that element, including the content, bounds, and positioning of the element. Customizations module 252 may be used to add visual customizations to the view elements (e.g., a customization that presents the view elements in black-and-white).

Editor 240 owns one or more selections (e.g., 242). A selection corresponds to the range of text, objects, or other elements of the rendered document which the user desires to edit. In one embodiment, the selection of or within the composite object corresponds to the semantic data of the composite object (e.g., bars in a bar chart, row of cells in a table, etc.) Selection 242 is created in response to external messages provided by external messaging 246 that correspond to mouse events, keyboard entries, and other external events corresponding to user inputs that edit composite object 212. Editor 240 decides whether or not to consume events, and if so, passes them to message handler 248 for this purpose. Message handler 248 decides which portion of view 230, if any, is responsible for handling the event from external messaging 246. The decision is based on hit testing data received from hit testing output 256 (described below). When editor 240 is responsible for consuming the event, editor 240 generates selection 242.

Each selection (e.g., 242) corresponds to the change to semantic data 214 or possibly presentation data 216 of composite object 212. In response to implementing selection 242, editor 240 provides an output corresponding to selection information to commands module 250. Commands module 250 interprets the editor output and performs an operation back onto composite object 212 that implements any changes to the content of composite object 212.

Editor 240 also generates selection view element 244. Selection view element 244 corresponds to the rendered representation of selection 242. Selection view element 244 may correspond to the highlighting of the text, the dots surrounding a shape, or other indicia that an element has been selected for editing. Similar to the view elements (e.g., 234, 236, 238), customizations (e.g., 252) may be applied to selection view element 244 prior to the rendering of view 230.

View 230 may be used to pass instructions to rendering layer 254 to render the view elements (e.g., 234, 236, 238) and any selection view elements (e.g., 244). Rendering layer 254 also includes hit testing output 256. Hit testing output 256 is queried by the view elements and selection view elements to determine whether the element was hit in response to an event from external messaging 246. From the hit testing data, an editor of view 230 is selected for handling the event. The chosen editor is then able to use the hit testing data corresponding to the elements to determine how to render view 230 with the changed made. In the case where no editor consumes the event, message handler 248 may export the event to other processes external to view 230 for handling.

Despite that system 200 is illustrated with functional blocks where only one functional block is shown (e.g., one anchor, 204), it is appreciated that multiples of the functional blocks may be included without departing from the spirit or scope of the invention. For example, multiple anchors may be included within a host application document that references multiple composite objects. Each of these composite objects may correspond to one or more composite object servers. Additionally, multiple editors and view elements may correspond to the composite objects when generating a view of the composite object in the host application document. These additional embodiments are similarly configured to provide integration of composite, data-driven objects within host applications.

Although system 200 shows how a composite object may be represented according to a composite object structure, the shape data of the composite object may also be represented according to the file format provided by the present invention. Composite object 212 may be rendered using the GVML of the present invention rather than using the composite object structure of system 200 that has the separation of semantic data and presentation data. The GVML provides its own hierarchical file format from which a rendered view of composite object 212 may be generated. When an application does not provide support for the composite object structures of system 200, GVML provides and alternate representation of the shape data that may be referenced to render the graphical object. As described in more detail below, a GVML file format may include a number of data structures, such as shape property bags, text property bags, group property bags, and other structures that are possibly arranged according their own hierarchy.

FIG. 3 illustrates a functional block diagram of an exemplary hierarchical shape property storage in accordance with one embodiment of the present invention. Hierarchical storage 300, or shape property bag (SPB) 300, includes objects (e.g., 302) that have hierarchical classes and values instead of flat nodes. For example, fill style object 302 includes a class 304 and a value 306. Class 304 indicates the class of the shape property object. For example, the class for object 302 is the fill style class 304 making object 302 a fill style object. Value 306 indicates that the fill style property of the shape associated with SPB 300 is solid fill type property (SolidFill). The objects that may be included in SPB 300 are not limited to fill styles and line styles as shown and may include any property that may be associated with a particular shape.

In one embodiment, the objects of SPB 300 are written according to an extensible markup language (XML) that lends to the hierarchical structure for the SPB. The object acts as bucket or container for storing a particular value associated with the property. In one embodiment, SPB 300 knows intrinsically which values (e.g., 306) are included in the objects (e.g., 302) so that queries into SPB may respond with the correct property information. The information in the objects corresponds to the value for the property that is currently associated with the shape. If the shape has a solid color fill, then the value included in the fill type object indicates a SolidFill value. If instead the shape has a pattern fill, then the fill type object indicates a PatternFill value. Other objects have multiple values, for example a geometry type object may include various values for defining the geometry of a shape. Since the values included in the objects are intrinsically known by SPB 300, there is no requirement for additional flags or properties within SPB 300 for locating the property information.

Illustrative Embodiments for a File Format for Hierarchically Describing Shapes

Aspects of the system and methods described herein are generally related to providing an XML file format that hierarchically describes shapes. This file format, referred to herein as GVML, corresponds to an XML schema that provides a way of describing a hierarchical set of shapes and text. The GVML provides a description of shapes that may be used in the context of a system (e.g., system 200) for embedded graphical objects. The shapes that are included in the graphical objects may include single shapes, group shapes that apply properties to a group of shapes, or text shapes that correspond to blocks or sections of text included in the graphical objects.

As the embedded object system is disseminated to the customers, a versioning support problem arises. GVML solves this problem by providing a representation of the graphical object that is understood by all versions of an application subsequent to the implementation of the new system. When embedded graphical objects are included in a document that is generated according to the new system, a user of previous solutions is still able to view these embedded graphical objects.

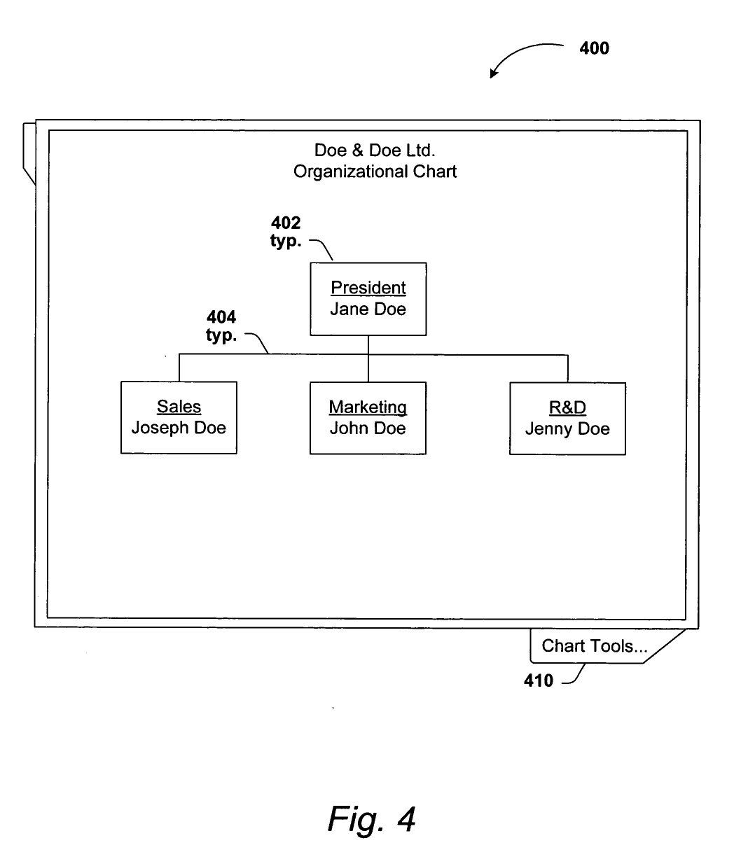

FIG. 4 illustrates a screenshot of an exemplary embedded graphical object that corresponds to an organizational chart in accordance with one embodiment of the present invention. Chart 400 is a type of graphical object that may be integrated in a host application as a composite object. Chart 400 provides a simple example of one type of graphical object that lends itself to storage a composite object. Other objects that take advantage of the composite object structure are bar charts, diagrams, tables, and other objects that may be presented visually by a combination of shapes and text.

While chart 400 may be represented by composite objects, chart 400 may also be represented according to GVML. The GVML provides a hierarchical structure for storing the shape and text properties of chart 400 according to its presentation data without persisting semantic data as with the composite object structure. An exemplary hierarchy for a GVML file is shown in FIG. 5 as described below.

Chart 400 also shows tab selector 410 that directs a user viewing the chart to a set of chart tools that are available for editing the chart. In one embodiment, tab selector 410 appears when a user has selected chart 400 in the host application document for editing or other manipulation. The chart tools option provides the user with the functionality of the application that the chart was originally created in while in the host application. In one embodiment, tab selector 410 is not available for editing the object when the object has been rendered from the GVML.

FIG. 5 illustrates a functional block diagram of an example hierarchy for organizing the properties of the shapes in accordance with one embodiment of the present invention. Hierarchy 500 includes nodes at various levels in the hierarchy. Additional embodiments may include additional node and/or levels without departing from the spirit of the invention.

In the current example, node 502 represents a typical root node of the hierarchy. The root node corresponds to the top level in the hierarchy. Properties may be applied to the shapes and text of the graphical object at the node 502 level. For example, a specific fill style and/or effect may be applied to all shapes and text included in the child nodes of node 502. A first child node to root node 502 is node 504.

Node 504 represents a typical group level node of the hierarchy. At the group level, properties may be applied to a group of shapes. For example, a user may desire to apply a shadow to a collection of rectangles rather than applying the shadow individually to each rectangle. The shadows of the individual rectangles may overlap if applied individually. Instead, applying the shadow to the group of shapes, ensures that no overlapping of multiple shadows results.

Node 506 represents a typical leaf node of the hierarchy. The leaf node of the hierarchy includes the SPB (e.g., 300) of a particular shape, possibly along with a text property bag. Structuring the GVML according to hierarchy 500 ensures that shapes may have collective properties applied along with individual properties so as to provide a representation of the graphical object that is as accurate as possible. In one possible embodiment, hierarchy 500 also leverages the hierarchical structure of the SPB, so that the hierarchy of the SPB is provided as a further extension of the hierarchy of the GVML.

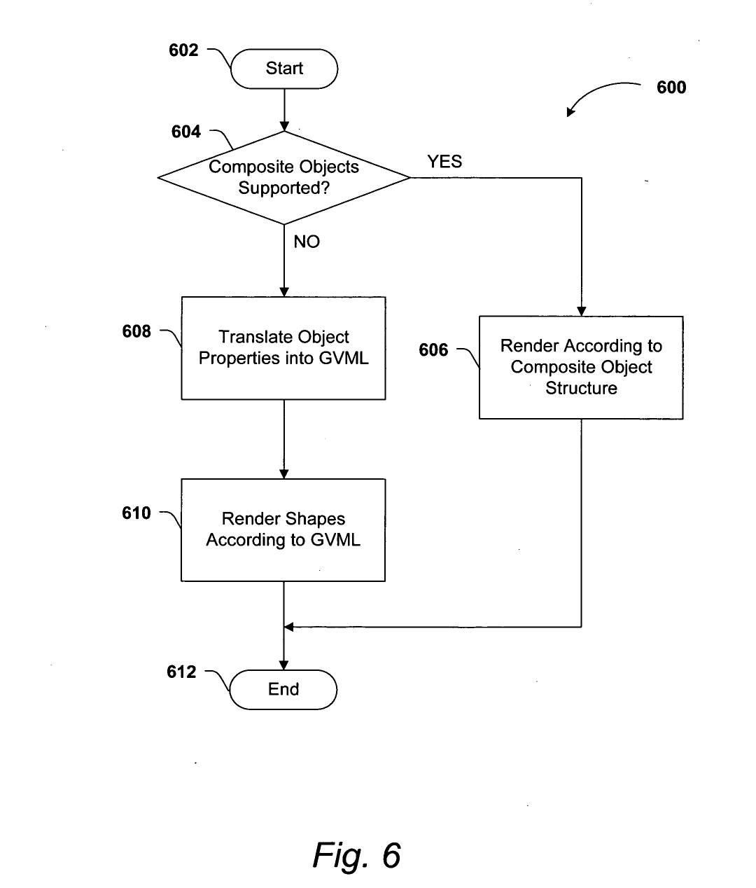

FIG. 6 shows a logical flow diagram of an exemplary process for rendering shapes according to a hierarchical file format, in accordance with one embodiment of the present invention. Process 600 starts at block 602 where a graphical object is generated according to the composite object structure provided in accordance with system 200 shown in FIG. 2. Processing continues at decision block 604.

At decision block 604, a determination is made whether the current application that includes the graphical object supports the composite object structure of the embedded object. The graphical object may have been embedded into the current or host application from its native application in which the graphical object was generated. The host application may be an earlier version of the application that has not been upgraded to fully support the composite object structure of the particular embedded object. If a determination is made that the current application does fully support the composite object structure of the embedded graphical object, processing moves to block 606.

At block 606, the graphical object is processed and rendered according to the methods provided by system 200 shown in FIG. 2. With the support of composite objects, the graphical object may be edited while embedded within the host application and also operates within the host application as the graphical object would operate in its own native application. Once the composite object is rendered to take advantage of its provided functionality, processing continues to block 612 where process 600 ends and processing moves onto other tasks.

If instead, the host application does not fully support the composite object structure of the graphical object, processing continues at block 608. At block 608, the shapes of the graphical object are translated into GVML according to the schema that provides the format and definitions for the GVML tags. In another embodiment, the shapes are already translated to GVML at the same time that the graphical object is transferred to the host application. Once translated to GVML, processing continues at block 610.

At block 610, the GVML is processed for rendering the graphical object within the host application so that the graphical object is output with the host application document. In one embodiment, the rendered shapes and text described by the GVML are not editable as with the same shapes and text rendered according to composite object structure. Accordingly, the GVML provides a representation of the shape data when the host application does not support the particular composite object embedded in the host application document. Once the shapes are rendered according to the GVML, processing continues to block 612 where process 600 ends and processing moves onto other tasks.

In an alternative embodiment, the present invention uses the GVML representation of the shape data for rendering the graphical object when the composite object server (210 of FIG. 2) is not found after a query for the server is made. In still another embodiment, the present invention uses the GVML as the language for transferring the shape data between documents. The documents may be associated with a single application or multiple applications. Once the shape data is transferred, the shape data may be retranslated to the composite object structure, or may be used to render the graphical object in the receiving document.

The process described in FIG. 6 may be repeated as necessary, and may have its process steps rearranged, certain process steps deleted, or additional process steps added without departing from the spirit or scope of the invention.

The use of the GVML is not limited as an alternate form for rendering the shapes of a graphical object. The alternate form provided by GVML is used by applications that support composite objects, but may not the support the particular composite object embedded in the document. In addition to using the GVML for rendering as described in FIG. 6, the GVML may also be used as a transfer mechanism between two applications that support rendering of shape hierarchies, but perhaps support them in very different ways. GVML, because it describes a shape hierarchy may be used to let the two applications transfer data when the composite object structure is not compatible between the applications.

The following includes a partial, exemplary computer program listing of GVML schemas for defining the format of the GVML for use in accordance with one embodiment the present invention:

======================================================
Gvml use shape anchor
===================================================-->
<xsd:complexType name=“CT_GvmlUseShapeRectangle” >

<xsd:annotation>
<xsd:documentation>

Indicates the text should the indicated text anchor from
its parent.

```
  </xsd:documentation>
</xsd:annotation>
<xsd:attribute name=“idx” type=“xsd:unsignedInt”
use=“optional” default=“0”>
  <xsd:annotation>
```

```
<xsd:documentation>
  If the parent shape doesn't define the chosen index,
  the index is ignored.
</xsd:documentation>
```

</xsd:annotation>
</xsd:attribute>

```
  ;</xsd:complexType>
  <!--
======================================================
Gvml text shape
===================================================-->
  <xsd:complexType name=“CT_GvmlTextShape” >
```

```
<xsd:sequence>
  <xsd:element name=“txBody”
  type=“CT_TextBody” minOccurs=“1” maxOccurs=“1”>
```

<xsd:annotation>
<xsd:documentation>

Actual text and text formatting.

</xsd:documentation>
</xsd:annotation>

```
  </xsd:element>
  <xsd:choice >
```

<xsd:element name=“xfrm” type=“CT_Transform2D”
minOccurs=“1” maxOccurs=“1”>
<xsd:annotation>

<xsd:documentation>
Text anchor rectangle.
</xsd:documentation>

```
  </xsd:annotation>
</xsd:element>
<xsd:element name=“useSpRect”
type=“CT_GvmlUseShapeRectangle”>
  <xsd:annotation>
```

```
<xsd:documentation>
  Indicates the text anchor rectangle is derived from
  a rectangle provided
  by its parent shape.
</xsd:documentation>
```

</xsd:annotation>
</xsd:element>

</xsd:choice>
</xsd:sequence>

```
  </xsd:complexType>
  <!--
======================================================
Gvml shape
===================================================-->
  <xsd:complexType name=“CT_GvmlShape” >
```

```
<xsd:sequence>
  <xsd:element name=“cdrElemPr”
  type=“CT_CommonDrawingElementProperties”
```

minOccurs=“1” maxOccurs=“1”>

<xsd:annotation>
<xsd:documentation>

Non-visual shape properties.

</xsd:documentation>
</xsd:annotation>

```
  </xsd:element>
  <xsd:element name=“spPr” type=“CT_ShapeProperties”
  minOccurs=“1” maxOccurs=“1”>
```

<xsd:annotation>
<xsd:documentation>

Visual shape properties.

</xsd:documentation>
</xsd:annotation>

```
  </xsd:element>
  <xsd:element name=“txsp” type=“CT_GvmlTextShape”
  minOccurs=“0”
```

maxOccurs=“unbounded”>

<xsd:annotation>
<xsd:documentation>

List of text shapes associated with this drawing
shape. Some effects, such as reflection, will
apply to a drawing shape's text shapes.

</xsd:documentation>
</xsd:annotation>

```
  </xsd:element>
  <xsd:element name=“style” type=“CT_ShapeStyle”
  minOccurs=“0” maxOccurs=“1” >
```

<xsd:annotation>
<xsd:documentation>

Shape style information.

</xsd:documentation>
</xsd:annotation>

</xsd:element>
</xsd:sequence>

```
  </xsd:complexType>
  <!--
======================================================
Gvml Composite Object frame
===================================================-->
  <xsd:complexType name=“CT_GvmlE2oFrame” >
```

```
<xsd:sequence>
  <xsd:element name=“cdrElemPr”
  type=“CT_CommonDrawingElementProperties”
```

minOccurs=“1” maxOccurs=“1”>

<xsd:annotation>
<xsd:documentation>

Non-visual E2o frame properties

</xsd:documentation>
</xsd:annotation>

```
  </xsd:element>
  <xsd:element name=“e2o” type=“CT_E2o” minOccurs=“1”
  maxOccurs=“1”>
```

<xsd:annotation>
<xsd:documentation>

E2o

</xsd:documentation>
</xsd:annotation>

```
  </xsd:element>
  <xsd:element name=“xfrm” type=“CT_Transform2D”
  minOccurs=“1” maxOccurs=“1”>
```

<xsd:annotation>
<xsd:documentation>

E2o frame anchor bounds.

</xsd:documentation>
</xsd:annotation>

</xsd:element>
</xsd:sequence>

```
  </xsd:complexType>
  <!--
======================================================
Gvml group shape
===================================================-->
  <xsd:complexType name=“CT_GvmlGroupShape” >
```

```
<xsd:sequence>
  <xsd:element name=“cdrElemPr”
  type=“CT_CommonDrawingElementProperties”
```

minOccurs=“1” maxOccurs=“1”>

<xsd:annotation>
<xsd:documentation>

Non-visual group shape properties

</xsd:documentation>
</xsd:annotation>

```
  </xsd:element>
  <xsd:element name=“gspPr”
  type=“CT_GroupShapeProperties” minOccurs=“1”
```

maxOccurs=“1”>

<xsd:annotation>
<xsd:documentation>

Visual group shape properties

</xsd:documentation>
</xsd:annotation>

```
  </xsd:element>
  <xsd:choice minOccurs=“0” maxOccurs=“unbounded”>
```

<xsd:element name=“txsp” type=“CT_GvmlTextShape”>
<xsd:annotation>

<xsd:documentation>
Text shape child.
</xsd:documentation>

```
  </xsd:annotation>
</xsd:element>
<xsd:element name=“sp” type=“CT_GvmlShape”>
  <xsd:annotation>
```

<xsd:documentation>
Drawing shape child.
</xsd:documentation>

```
  </xsd:annotation>
</xsd:element>
<xsd:element name=“e2oFrame” type=“CT_GvmlE2oFrame”>
  <xsd:annotation>
```

<xsd:documentation>
E2o child.
</xsd:documentation>

```
  </xsd:annotation>
</xsd:element>
<xsd:element name=“gsp” type=“CT_GvmlGroupShape”>
  <xsd:annotation>
```

<xsd:documentation>
Group shape child.
</xsd:documentation>

</xsd:annotation>
</xsd:element>

</xsd:choice>
</xsd:sequence>

</xsd:complexType>
</xsd:schema>

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-readable medium having stored thereon a hierarchical data structure for representing shapes of a composite object, comprising:
a first data field containing data representing a schema that defines the format of the hierarchical data structure;
a second data field containing data representing a first set of shape properties of the hierarchical data structure that correspond to properties applied to a group of shapes included in the composite object; and
a third data field containing data representing a second set of shape properties of the hierarchical data structure that correspond to properties applied to a particular shape included in the composite object, wherein third data field represents a data field lower in the hierarchical data structure from the second data field.

2. The computer-readable medium of claim 1, wherein the first set of shape properties corresponds to properties applied to a particular level in the hierarchical data structure.

3. The computer-readable medium of claim 1, wherein second set of shape properties corresponds to a shape property bag associated with the particular shape.

4. The computer-readable medium of claim 1, wherein second set of shape properties correspond to a leaf node within the hierarchical data structure.

5. The computer-readable medium of claim 1, wherein hierarchical data structure is provided as extensible markup language (XML).

6. The computer-readable medium of claim 1, further comprising a fourth data field representing text properties and content applied to the group of shapes.

7. The computer-readable medium of claim 6, further comprising a fifth data field representing text properties and content applied to the particular shape.

8. The computer-readable medium of claim 1, wherein the schema defines that the hierarchical data structure is used to render the shapes of the composite object when the composite object is unsupported by an application attempting to render the shapes according to the composite object structure.

9. The computer-readable medium of claim 1, wherein the schema defines that the hierarchical data structure is used to render the shapes of the composite object when a server that provides rendering according to the composite object structure is not found for rendering the composite object.

10. The computer-readable medium of claim 1, wherein the schema defines that the hierarchical data structure is used for transferring a composite object from a first document to a second document.

11. A computer-implemented method for rendering shapes of a composite object by referencing a hierarchical file format, the method comprising:
determining whether an application supports the composite object, wherein support for the composite object is provided when the application corresponds to a version that is capable of rendering the composite object according to a composite object structure;
translating properties of the shapes for inclusion in the hierarchical file format when the application does not support the composite object; and
rendering the shapes according to the hierarchical file format, wherein the hierarchical file format provides the properties for generating a rendered view of the composite object.

12. The computer-implemented method of claim 11, wherein the hierarchical file format is provided using extensible markup language (XML).

13. The computer-implemented method of claim 11, wherein the hierarchical file format is defined according to a schema.

14. The computer-implemented method of claim 11, wherein the schema further defines that the hierarchical file format renders the shapes of the composite object when a server that provides rendering according to the composite object structure is not found for rendering the composite object.

15. The computer-implemented method of claim 11, wherein the schema further defines that the hierarchical file format is used to transfer a representation of the composite object from a first document to a second document.

16. The computer-implemented method of claim 11, wherein the properties include group shape properties that are applied to groups of shapes and shape properties that are applied to a particular shape, wherein the shape properties are lower in the hierarchy than the group shape properties.

17. The computer-implemented method of claim 11, wherein the properties include text properties and content applied to the shapes.

18. A computer-readable medium having stored thereon instructions that when executed implements the computer-implemented method of claim 11.

19. A system for rendering shapes of a composite object by referencing a hierarchical file format, comprising:
a computing device; and
a memory associated with the computing device, the memory having stored thereon and computer-executable instructions for rendering shapes of a composite object by referencing a hierarchical file format, the computer-executable instructions comprising:
generating the hierarchical file format according to a schema that defines the structure of the hierarchical file format that may be used in association with the shapes,
determining whether an application supports the composite object, wherein support for the composite object is provided when the application corresponds to a version that is capable of rendering the composite object according to a composite object structure,
translating properties corresponding to the shapes according to structure defined by the schema so that the properties are included in the hierarchical file format when the application does not support the composite object, and
rendering the shapes according to the hierarchical file format, wherein a rendering engine references the hierarchical file format for generating a rendered view of the composite object.

20. A computer-readable medium having stored thereon instructions that when executed implements the system of claim 19.
